(19) United States
(12) Patent Application Publication
(10) Pub. No.: US 2020/0288671 A1
(43) Pub. Date: Sep. 17, 2020

(54) PET TOY

(71) Applicant: Doskocil Manufacturing Company, Inc., Arlington, TX (US)

(72) Inventors: Thi Thanh NGUYEN, Arlington, TX (US); Hoai Nam VO, Arlington, TX (US)

(21) Appl. No.: 16/818,234

(22) Filed: Mar. 13, 2020

Related U.S. Application Data
(60) Provisional application No. 62/818,244, filed on Mar. 14, 2019.

(51) Int. Cl. A01K 15/02

(52) U.S. Cl. CPC A01K 15/025

(57) ABSTRACT

A pet toy includes an outer covering and an inner core. The inner core has an outer surface formed with a non-linear groove. The outer covering has a first section and a second section. The first section is fixed to a first area of the outer surface of the inner core and the second section is disposed at least partially within the groove.

### CROSS-REFERENCE TO RELATED APPLICATION

This application claims benefit of U.S. Provisional Application No. 62/818,244 filed Mar. 14, 2019, the contents of which are hereby incorporated herein by reference.

### BACKGROUND

### Field of the Invention

The present invention relates to a pet toy. In particular, the present invention is directed to pet ball configured to be thrown and then fetched by an animal.

### Background of the Invention

Conventional pet toys can be thrown and fetched. Many of these toys are not sufficiently rugged to stand up to repeated chewing and play.

### SUMMARY

It has been determined that an improved pet toy is desirable.

One object of the present invention is to provide a pet toy with a ball shape and a recess that provides an added dimension to the surface of the pet toy.

In view of the state of the art, one embodiment of the present invention is directed to a pet toy that includes an outer covering and an inner core. The inner core has an outer surface formed with a non-linear groove. The outer covering has a first section and a second section. The first section is fixed to a first area of the outer surface of the inner core and the second section is disposed at least partially within the groove.

### BRIEF DESCRIPTION OF THE DRAWINGS

The invention will be explained in more detail hereinafter with reference to the drawings.

FIG. 1 is a front view of the pet toy showing first portions and second portions of a non-linear groove formed along the surface of the pet toy, the non-linear groove having an overall shape similar to the shape of baseball stitching in accordance with an exemplary embodiment;

FIG. 2 is a left side view of the pet toy with the pet toy rotated 90 degrees leftward about a vertical axis relative to FIG. 1 in accordance with the exemplary embodiment;

FIG. 3 is a backside view of the pet toy with the pet toy rotated 180 degrees leftward about the vertical axis relative to FIG. 1 in accordance with the exemplary embodiment;

FIG. 4 is a right-side view of the pet toy with the pet toy rotated 90 degrees rightward about the vertical axis relative to FIG. 1 in accordance with the exemplary embodiment;

FIG. 5 is a top side view of the pet toy with the pet toy rotated 90 degrees downward about a horizontal axis relative to FIG. 1 in accordance with the exemplary embodiment;

FIG. 6 is a bottom side view of the pet toy with the pet toy rotated 90 degrees upward about the horizontal axis relative to FIG. 1 in accordance with the exemplary embodiment;

FIG. 7 is a perspective view of the pet toy in accordance with the exemplary embodiment;

FIG. 8 is a cross-sectional view of a portion of the pet toy showing an inner core, an outer covering that includes a first section and a second section, the second section lining surfaces of the non-linear groove and further defining the non-linear groove, a peripheral edge of the second section overlapping a recessed edge of the first portion thereby defining a recess exposing a portion of the recessed edge of the first portion in accordance with the exemplary embodiment;

FIG. 9 is a plan view of a part of the first section of the outer covering removed from the pet toy showing a recessed edge form along an outer periphery thereof in accordance with the exemplary embodiment;

FIG. 10 is a plan view of a portion of the pet toy showing the groove and the peripheral edge of the second section of the outer covering overlapping the recessed edge of the first section of the outer covering and further showing the recess that exposes a portion of the recessed edge of the first section of the outer covering in accordance with the exemplary embodiment;

FIG. 11 is another plan view of the portion of a modified version of the pet toy depicted in FIG. 10 showing the groove and the peripheral edge of the second section of the outer covering overlapping the recessed edge of the first section of the outer covering without the recess shown in FIG. 10 in accordance with the exemplary embodiment;

FIG. 12 is a cross-section of a first pair of rollers that press material into a thin sheet in order to form the first section of the outer covering of the pet toy in accordance with the exemplary embodiment;

FIG. 13 is a perspective view of molded material being cut to remove flashing in one step of the formation of the second section of the outer covering of the pet toy in accordance with the exemplary embodiment;

FIG. 14 is a perspective view of a precision cutting device that cuts the molded material shown in FIG. 13 to predetermined dimensions to form the second section of the outer covering of the pet toy in accordance with the exemplary embodiment;

FIG. 15 a perspective view of an optional sewing machine that joins opposing ends of the second section of the outer covering to form a continuous loop that is subsequently inserted into the groove of the inner core and overlapping with edges of the first section of the outer covering of the pet toy in accordance with the exemplary embodiment;

FIG. 16 is a cross-section of a second pair of rollers that press the thin sheet (formed by the first pair of rollers as shown in FIG. 12) in order to form or emboss a logo onto the outer surface of the first section of the outer covering of the pet toy in accordance with the exemplary embodiment;

FIG. 17 is a top view of a first mold having a semi-spherical concaved portion that is used to vulcanize the pet toy after assembly in accordance with the exemplary embodiment;

FIG. 18 is a bottom view of a second mold having a semi-spherical concaved portion that is used along with the first mold to vulcanize the pet toy after assembly in accordance with the exemplary embodiment;

FIG. 19 is a plan view of one of a plurality of mold inserts that are fitted into the groove of the pet toy during vulcanization of the pet toy in accordance with the exemplary embodiment;

FIG. 20 is a first perspective view of the one of the plurality of mold inserts that are fitted into the groove of the pet toy during vulcanization of the pet toy in accordance with the exemplary embodiment;

FIG. 21 is a second perspective view of the one of the plurality of mold inserts that are fitted into the groove of the pet toy during vulcanization of the pet toy in accordance with the exemplary embodiment;

FIG. 22 is a perspective view of the assembled pet toy with the plurality of mold inserts fitted within the groove of the pet toy and with the pet toy fitted into the semi-spherical concaved portion of the first mold prior to vulcanization in accordance with the exemplary embodiment; and

FIG. 23 is a side view of the first and second molds fitted to one another with the assembled pet toy and disposed within the semi-spherical concaved portions of the first and second molds during vulcanization in accordance with the exemplary embodiment.

### DETAILED DESCRIPTION OF THE EMBODIMENTS

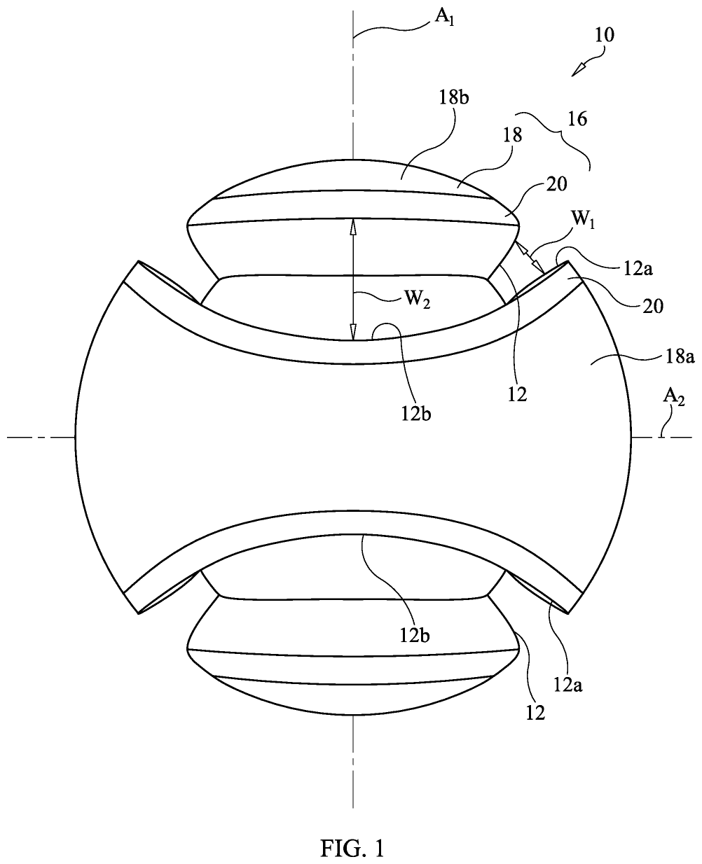

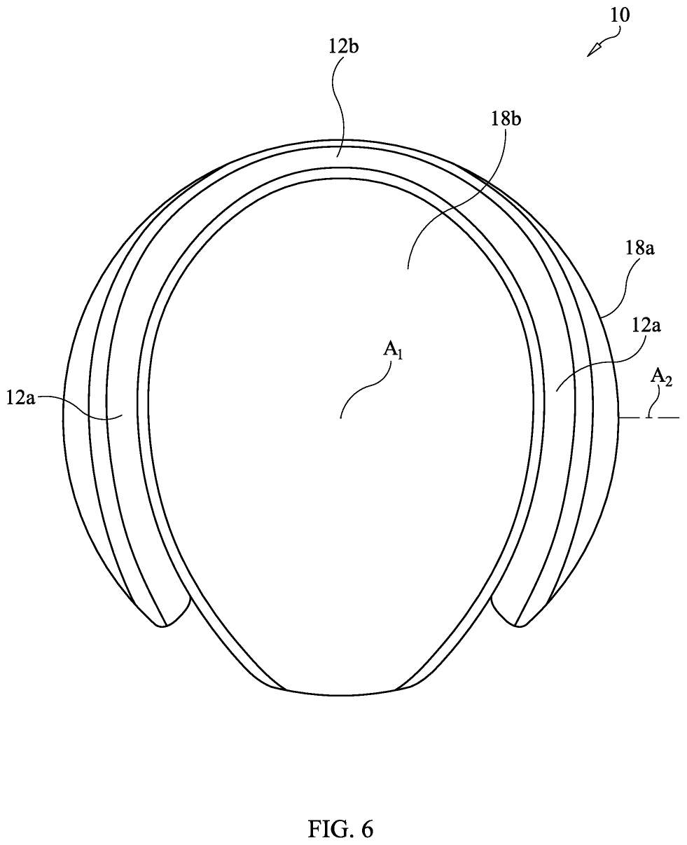

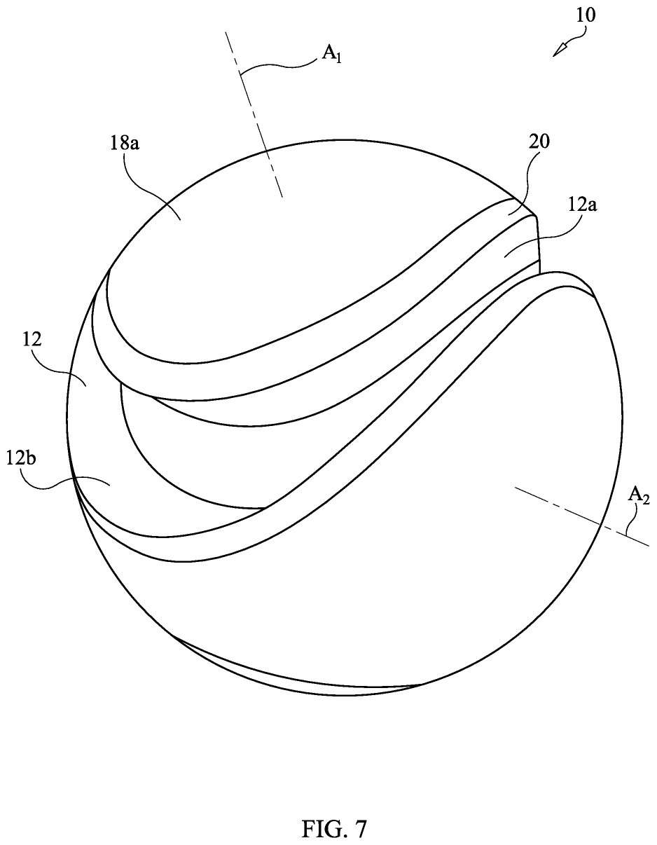

FIGS. 1-7 illustrate a pet toy 10 in accordance with an embodiment of the present invention. In particular, the pet toy 10 is a throwable ball that can be retrieved and easily carried by an animal. The pet toy 10 is generally spherical, such that it is capable of rolling along a surface. However, the pet toy 10 can be any suitable shape, such as oblong, like a football or any other shape.

In the depicted embodiment in FIGS. 1-7, the pet toy 10 is depicted as having a non-linear groove 12 (also referred to herein below as the groove 12). The groove 12 has a curved, serpentine shape that resembles the path and overall shape of stitching used on the skin of a professional baseball.

In FIGS. 1-7, the pet toy 10 is drawn with two imaginary perpendicular axes A₁ and A₂. The axis A₁ is vertical and the axis A₂ is horizontal as depicted in FIG. 1. The axes A₁ and A₂ are included in FIGS. 1-7 to provide a reference point in relating the various views of FIGS. 1-7. The terms front, back, side, top and bottom when used in characterizing FIGS. 1-6 are merely to demonstrate the relationships between the appearance of differing areas of the pet toy 10, and specifically, the shape and size of the different portions of the groove 12 of the pet toy 10.

Specifically, FIG. 1 is a front view of the pet toy 10 showing first portions 12a of the groove 12 and second portions 12b of the groove 12. The first portions 12a of the groove 12 have a first width W₁ and the second portion 12b of the groove 12 have a second width W₂ that is greater than the first width W₁. The second width W₂ is greater than twice the first width W₁. The groove 12 is non-linear and follows a path that is similar to shape and path of stitching of a professional baseball. The groove 12 can also be formed with a serpentine-like shape. The groove 12 has an increasing width moving from the first portion to the second portion 12b. More specifically, in the areas between the first portion 12a and 12b, the width of the groove 12 gradually changes moving from one of the portions 12a and 12b to the other of the portions 12a and 12b of the groove 12, as is shown in FIGS. 1-7.

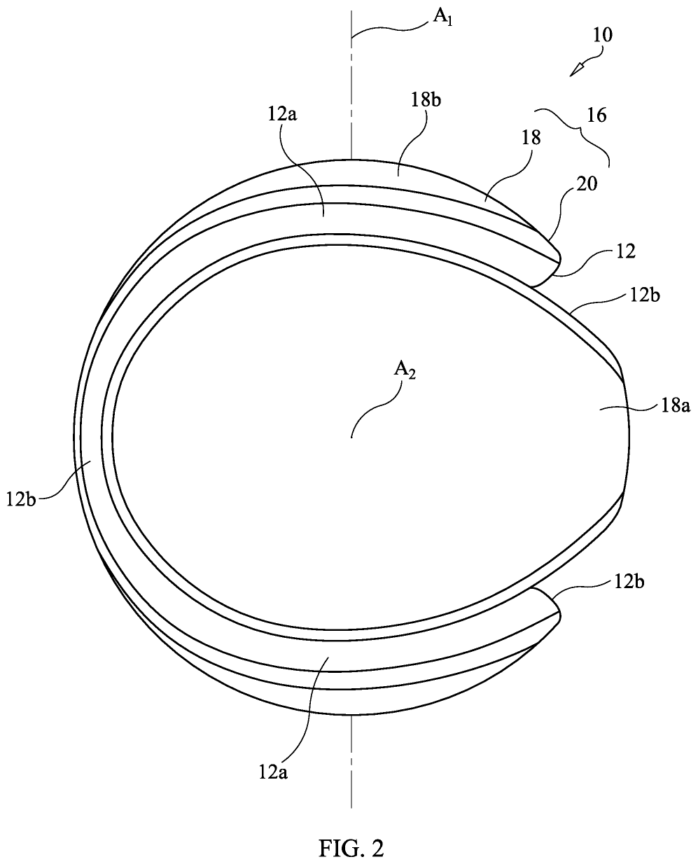

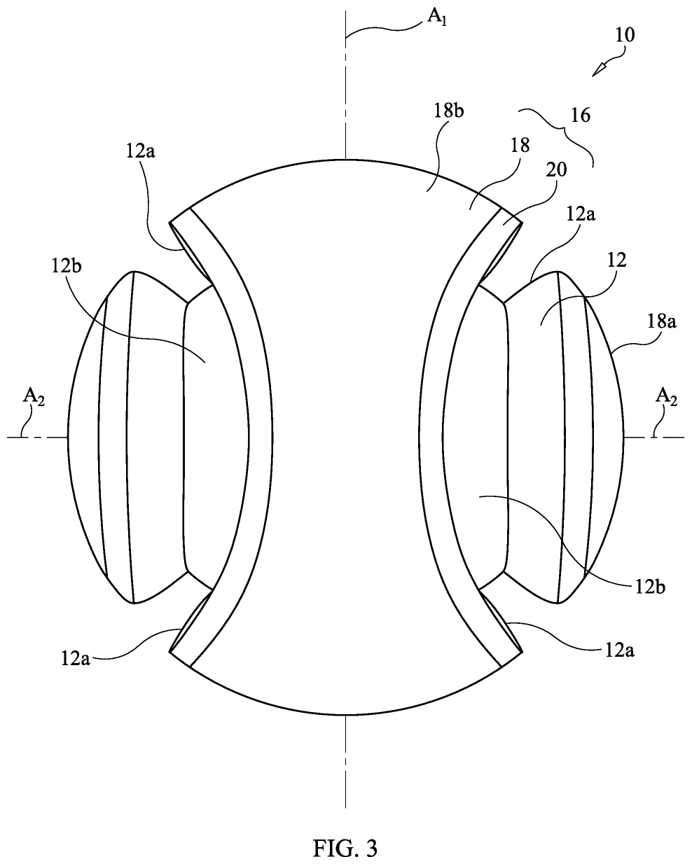

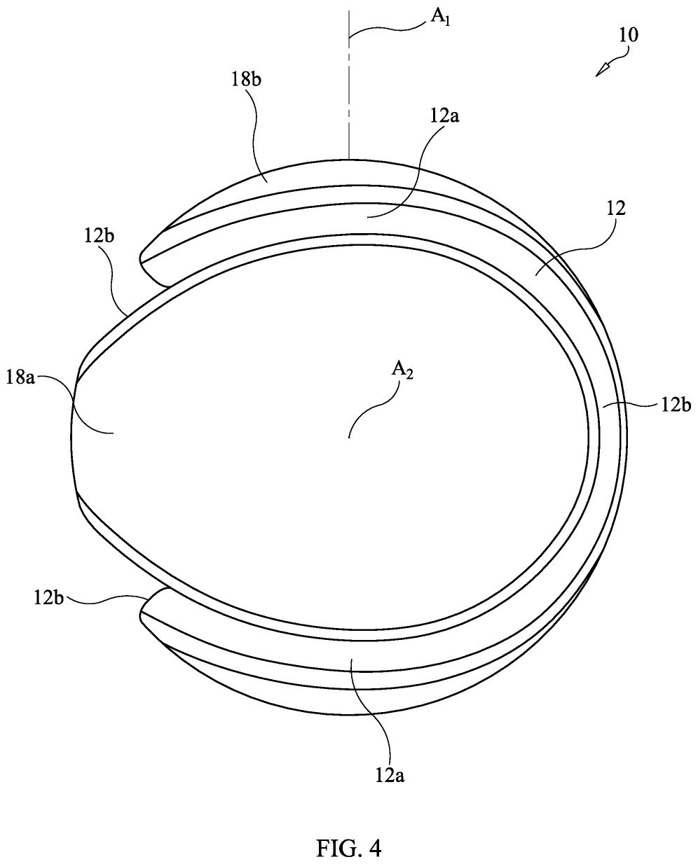

FIG. 2 is a left side view of the pet toy 10 with the pet toy rotated 90 degrees left about the axis A₁ relative to FIG. 1. FIG. 3 is a backside view of the pet toy 10 with the pet toy rotated 180 degrees left about the axis A₁ relative to FIG. 1 (rotated 90 degrees from FIG. 2). FIG. 4 is a right-side view of the pet toy 10 with the pet toy rotated 270 degrees left about the axis A₁ relative to FIG. 1 (rotated 90 degrees from FIG. 3).

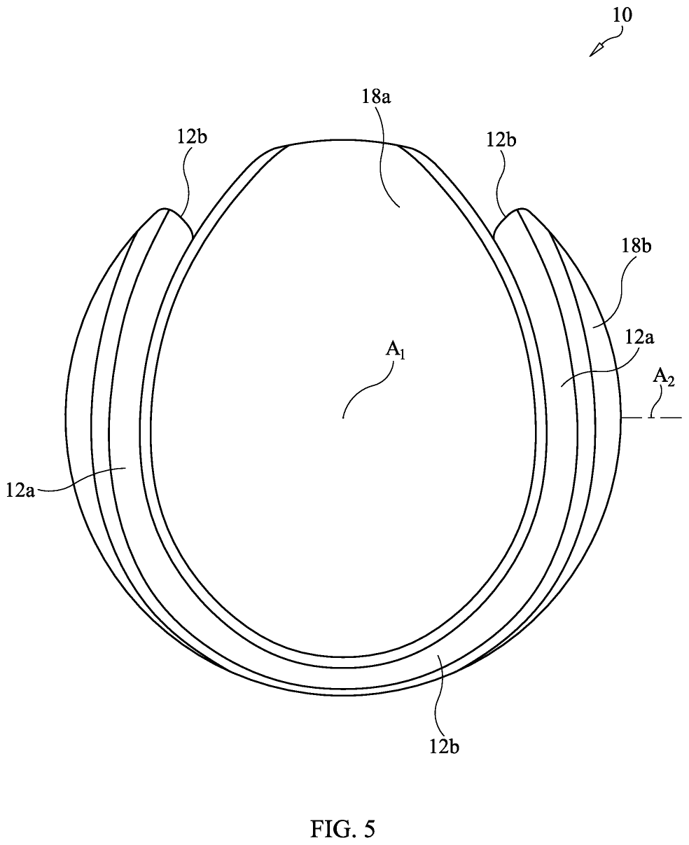

FIG. 5 is a top side view of the pet toy 10 with the pet toy rotated 90 degrees downward about the axis A₂ relative to FIG. 1. FIG. 6 is a bottom side view of the pet toy 10 with the pet toy rotated 90 degrees upward about the axis A₂ relative to FIG. 1.

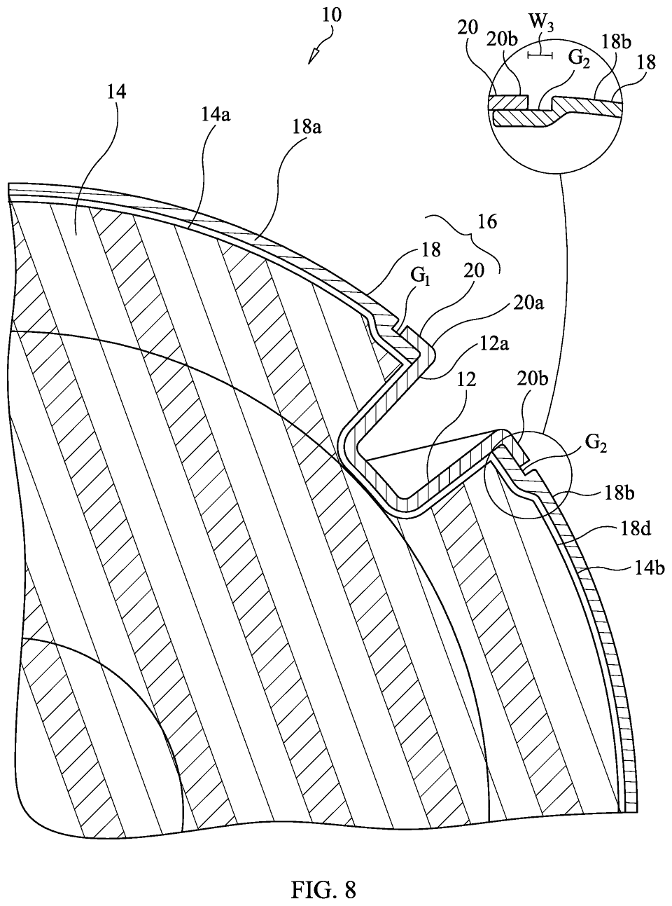

As shown in cross-section in FIG. 8, the pet toy 10 preferably has an inner core 14 and an outer covering 16. The inner core 14 is preferably generally spherical or round and is formed from a copolymer, such as Ethylene vinyl acetate (EVA). Eva is a copolymer of ethylene and vinyl acetate. EVA is an elastic material that can be sintered to form a porous material similar to rubber, yet with excellent toughness. However, the core 14 can be formed from any suitable material.

The core 14 is formed with the groove 12 along portions of the outer surface thereof. The groove 12 is preferably a single continuos groove that extends in a curved manner along the surface of the core 14. Portions of the groove 12 have a generally rectangular cross section so to form a generally U-shape. Other than the inclusion of the groove 12, the core 14 can be solid or have a hollow central portion depending upon the overall design of the pet toy 10 and/or the manufacturing techniques used to form the pet toy 10.

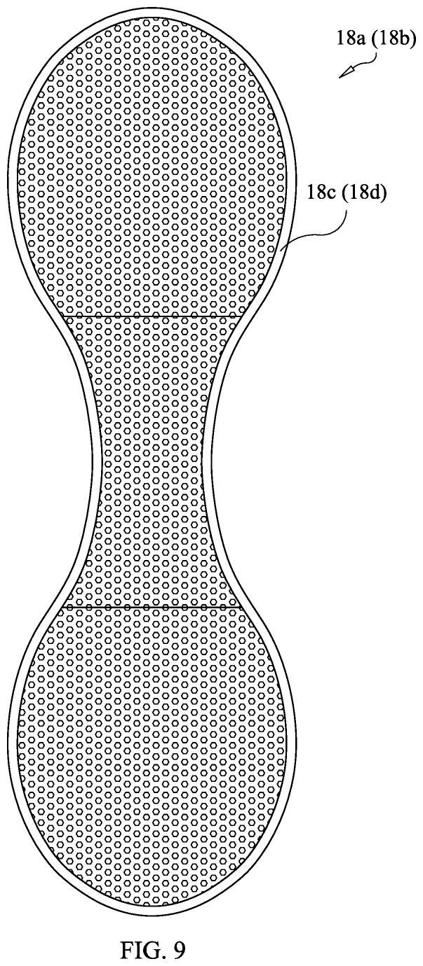

The outer covering 16 includes a first section 18 and a second section 20. The first section 18 includes identical first and second parts 18a and 18b. As shown in FIG. 9, the first part 18a and the second section 18b have an overall barbell-like shape prior to being attached to the core 14 and laid flat. Specifically, opposing ends have a semi-spherical shape with a narrowed mid-section that joins the opposing ends thereof. As shown in FIG. 8, (and in FIGS. 1-7), the first part 18a fixed to a first area 14a of the outer surface of the inner core 14 and the second part 18b of the first section 18 is fixed to a second area 14b of the outer surface of the inner core 14.

The second section 20 of the outer covering 16 is partially disposed within the groove 12, extending along a bottom surface and side surfaces of the groove 12. The second section 20 further includes peripheral edges 20a and 20b that overlap corresponding recessed edges 18c and 18d of the first part 18a and the second part 18b of the first section 18, as shown in FIG. 8. The peripheral edges 20a and 20b extend the entire length of the second section 20, and, similarly extend adjacent to opposing sides of the groove 12. The recesses or recessed edge 18c of the first part 18a extends completely around the outer periphery of the first part 18a. The recessed edge 18d of the second part 18b extends completely around the outer periphery of the second part 18b, as shown in FIG. 9.

The second section 20 extends along the entire length of the groove 12 and completely lines the surfaces of the groove 12 and covers the groove 12, while maintaining the overall shape and contours of the groove 12 (as viewed along the exterior of the pet toy 10).

As is shown in FIG. 8 (as well as FIGS. 1-7) the groove 12 and the second section 20 separates the first part 18a from the second part 18b of the first section 18. In other words, the second section 20 contacts both the first part 18a and the second part 18b of the first section 18. However, the first part 18a and the second part 18b do not contact one another and area separated from one another with the groove 12 and the second section 20 extending therebetween.

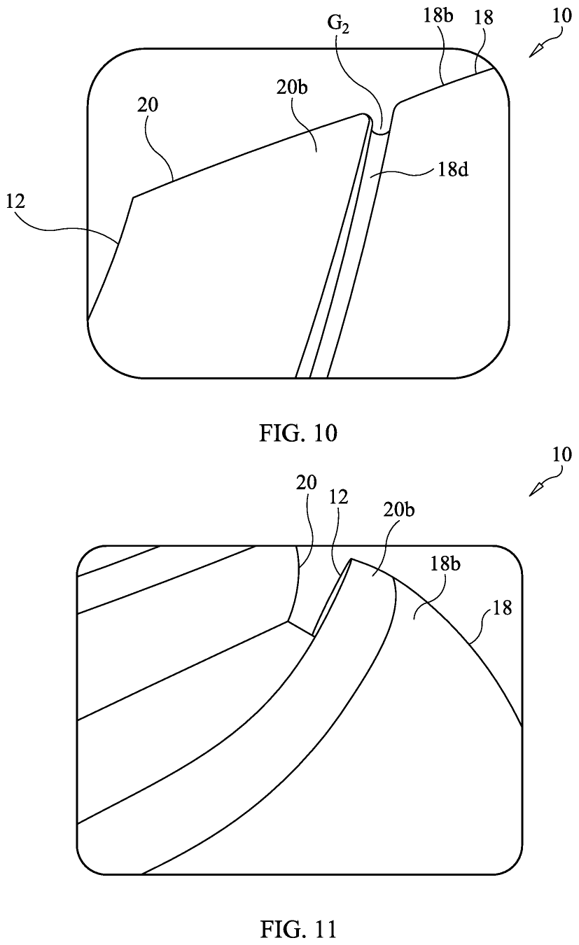

As shown in FIGS. 8 and 10, the first peripheral 20a of the second section 20 can be cut or formed such that a small gap or recess G₁ is defined along the end surface of the first peripheral edge 20a exposing a portion of the recessed edge 18c. Similarly, the second peripheral 20b of the second section 20 can be cut or formed such that a small gap or recess G₂ is defined along the end surface of the second peripheral edge 20b exposing a portion of the recessed edge 18d. The recesses G₁ and G₂ define a third width W3 that is approximately 30% of the first width W₁ or less.

Alternatively, the pet toy 10 can be formed without the recesses G₁ and G₂ such that the peripheral edges 20a and 20b of the pet toy 10 are flush with the outer surface of the first parts 18a and 18b of the first section 10, thereby completely covering and concealing the recessed edges 18c and 18d, as indicated in FIG. 11.

The first section 18 and a second section 20 of the outer covering 16 can be formed of any of a variety of materials, such as synthetic rubber, rubber, copolymers or resin-based materials. In the depicted embodiment the outer covering 16 is made of rubber, as described further below.

Those portions of the first section 18 and a second section 20 of the outer covering 16 that contact the outer surface of the core 14 are fixedly attached thereto by, for example, an adhesive or, by a heating and/or vulcanizing process.

It should be understood from the drawings and the description herein, that the first and second parts 18a and 18b can have the same or a similar overall shape, dimensions and configuration and appear as a three dimensional C, as is indicated in FIGS. 2, 4, 5 and 6.

The groove 12 can vary in diameter and depth, such that the groove 12 has a varying configuration along a length thereof. Thus, in one portion of the groove the first and second parts can define respective edges that are generally parallel. However, in another portion of the groove an edge of the first part can be curved relative to the edge of the second part.

In the depicted embodiment, the first section 18 (including the first part 18a and the second part 18b) and the second section 20 are approximately 2 mm thick but can be any suitable thickness. The recesses G₁ and G₂ preferably have a width of about 2 mm. The first portion 12a of the groove 12 can have a width of between 1 and 2 cm, and, the second portion 12b can have a width of between 2 and 4 cm. The overall diameter of the pet toy can be any where between 12 cm and 40 cm. The groove 12 are depressions that define flange areas that can make it easier for a pet to bite or otherwise manipulate the pet toy 10.

The pet toy 10 can be formed in any of a variety of processes. The following description and the depictions in FIGS. 12 through 23 show one example of a method of manufacturing the pet toy 10.

First, the core 14 can be molded to form the desired shape (not show), such as a generally spherical ball with the groove 12 (without the second section 20 covering surfaces of the groove 12). Since molding processes are conventional manufacturing processes, further description of the molding of the core 14 is omitted for the sake of brevity.

Next, as shown in FIG. 12, the material that comprises the first section 18 of the outer covering 16 is weighed and then fed to rollers R₁ and R₂ that squeeze the material to the left of the rollers R₁ and R₂ into a thin flat layer of material that subsequently is cut to size to define the first section 18. The rollers R₁ and R₂ can be heated or the surroundings can be heated in order to achieve the desired thickness of the first section 18.

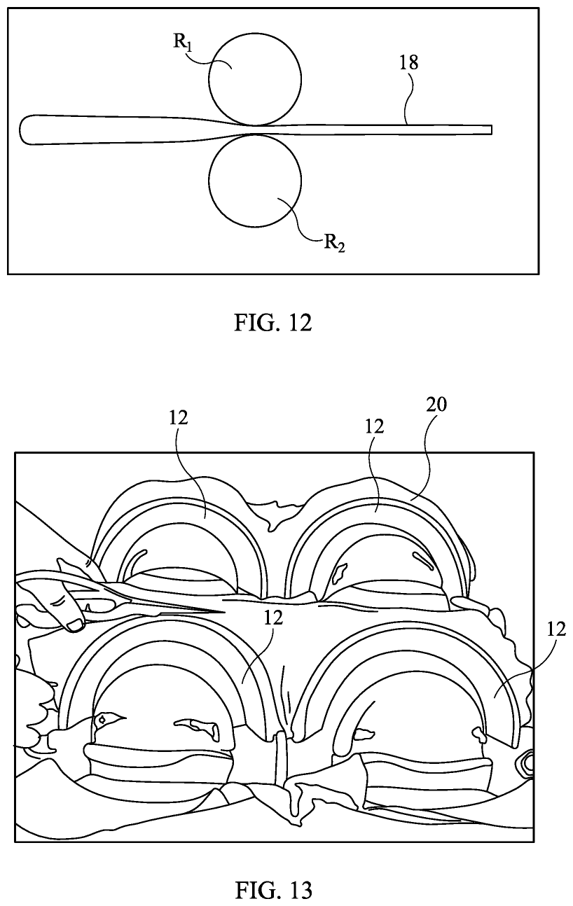

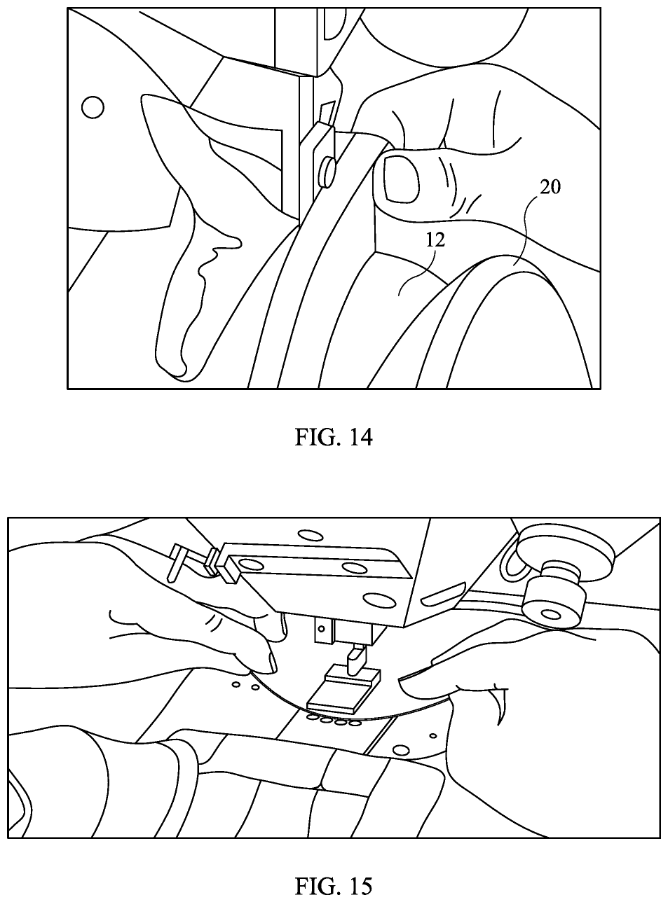

As shown in FIGS. 13 and 14, the second section 20 of the outer covering 16 is formed by hydraulic press for rubber vulcanization. As shown in FIG. 14, the second section 20 of the outer covering 16 is then pavia cut to form the finalized U-shaped configuration that subsequently is fitted into the groove 12.

As shown in FIG. 15, the second section 20 of the outer covering 16 can then be sewn together by needle zigzag sewing to make a continuous loop or strip that is subsequently fitted into the groove 12. It should be understood that sewing is not the only process that can be used to form the continuos strip that defines the second section 20. For example, the sections of the material that defines the second section 20 can be temporarily glued or heat melted to one another to form the continuous strip that fits into the groove 12.

Further, in an alternative embodiment (not shown) the first section 18 and the second section 20 of the outer covering 16 can be sewn together.

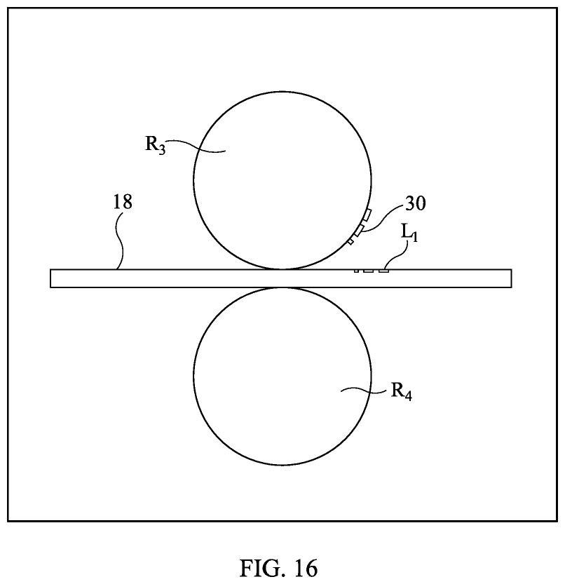

As shown in FIG. 16, the first section 18 of the outer covering 16 can optionally be passed through a second set of rollers R₃ and R₄ in order to form a logo L1 on the first section 18. Specifically, the roller R₃ includes embossments 30 that are impressed onto the surface of the first section 18 molding the logo L₁ thereon. The rollers R₃ and R₄ can be heated or the surroundings can be heated in order impose the shape of the embossments 30 into or onto the first section 18 of the outer covering 16. The first sections 18 are then cut to the desired shape shown in FIG. 9 forming the first part 18a and the second part 18b.

Next, the first part 18a and the second part 18b of the first section 18 of the outer covering 16 are applied to the core 14 at predetermined locations. Thereafter, the second section 20 is installed to the groove 12 with the peripheral edges 20a and 20b overlapping the recessed edges 18c and 18d.

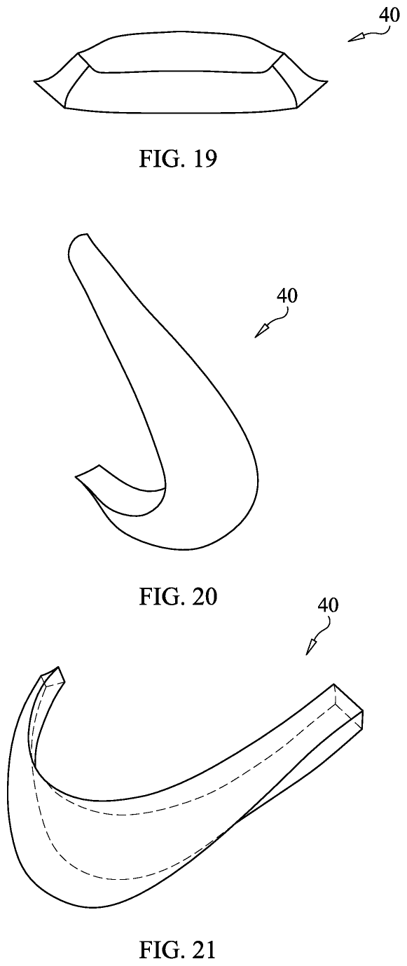

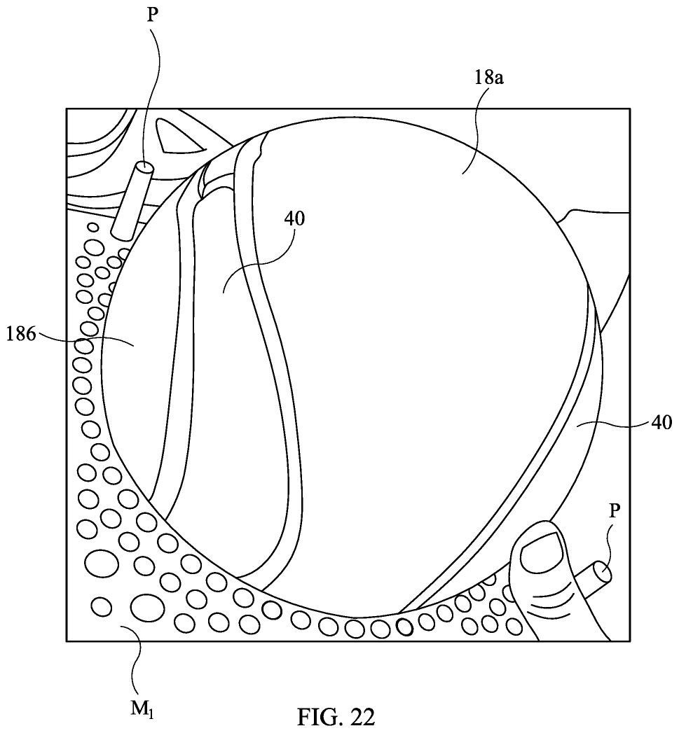

Next, a plurality of mold inserts 40 shown in FIGS. 19-21 inserted are fitted to corresponding sections of the recess 12, as shown in FIG. 22. The plurality of mold inserts 40 are shaped to form or maintain the overall shape of the recess 12. Each mold insert 40 is shaped to correspond to approximately 25% of the entire recess 12. Each of the plurality of inserts 40 are identical with ends thereof being dimensioned to correspond to the first width W₁ and a central section thereof dimensioned to correspond to the second width W₂.

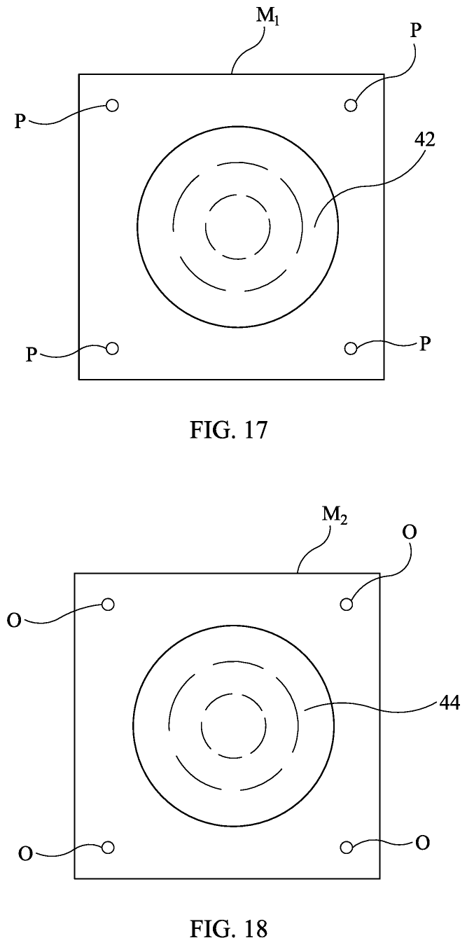

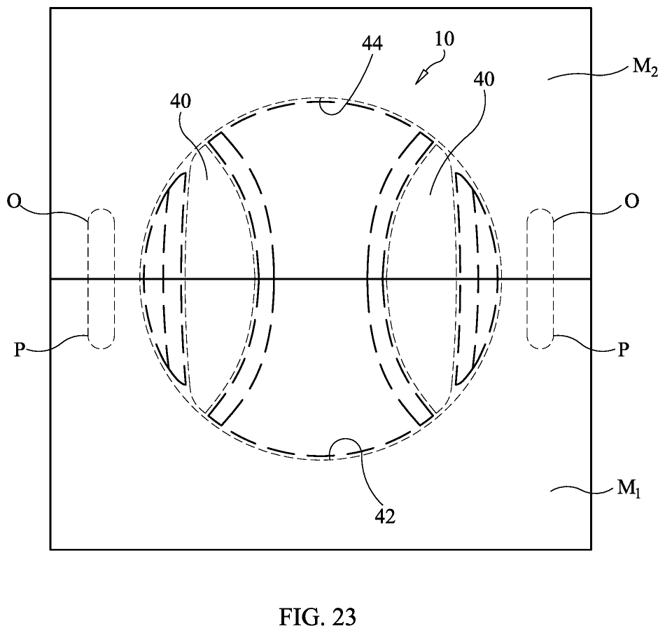

Next, pet toy 10 with the mold inserts 40 are placed into a mold having a first mold M₁ shown in FIGS. 17 and 22-23 and a second mold M₂ shown in FIGS. 18 and 23.

As shown in FIG. 23, the assembled pet toy 10 is then encased within the first and second molds M₁ and M₂ and autoclaved (heating and/or pressurizing) for vulcanizing to form the finish pet toy 10. Afterward, the completed pet toy 10 is removed from the molds and the mold inserts and packaged for sale. It should be understood from the drawings and the description herein that any of a variety of vulcanizing processes can be employed depending upon the materials used to form the pet toy 10 and the desired outer covering characteristics desired. Since vulcanizing processes are well know in the art, further description is omitted for the sake of brevity.

Thus, the second section 20 of the outer covering 16 is adhered within the groove 12 of the inner core 14 so as to complete and form the groove 12 in the exterior of the pet toy 10. The resultant pet toy 10 is resistant to chewing by an animal, water resistant or water proof for use in wet weather or in water. Moreover, the groove 12 is sized and configured to enable an animal to grip the top of the pet toy 12 along the groove 12 with their teeth for easy retrieval and carrying.

What is claimed is:

1. A pet toy comprising:
an inner core having an outer surface formed with a non-linear groove; and
an outer covering having a first section and a second section, the first section being fixed to a first area of the outer surface of the inner core and the second section being disposed at least partially within the groove.

2. The pet toy according to claim 1, wherein
the inner core is formed from a copolymer.

3. The pet toy according to claim 1, wherein
the outer surface of the inner core has an overall spherical shape with the non-linear groove formed therein.

4. The pet toy according to claim 1, wherein
the groove has a serpentine-like shape.

5. The pet toy according to claim 1, wherein
a first portion of the groove has a first width and a second portion of the groove has a second width that is greater than the first width.

6. The pet toy according to claim 5, wherein
the second width is greater than twice the first width.

7. The pet toy according to claim 1, wherein
the first section includes a first part and a second part, the first part being fixed to a first portion of the first area of the outer surface of the inner core and the second part of the first section being fixed to a second portion of the first area of the outer surface of the inner core.

8. The pet toy according to claim 8, wherein
each of the first part and the second part of the first section has a barbell-like shape.

9. The pet toy according to claim 7, wherein
the second section extends along an entire length of the groove and completely lines and covers the groove.

10. The pet toy according to claim 7, wherein
the groove and the second section separate the first part and the second part of the first section.

11. The pet toy according to claim 7, wherein
the second section has opposing peripheral edges extending the entire length of the groove, a first of the opposing peripheral edges overlaps with an edge portion of the first part of the first section and a second of the opposing peripheral edges overlaps with an edge portion of the second part of the first section.

12. The pet toy according to claim 11, wherein
the first of the opposing peripheral edges of the second section defines a first recess that extends along the edge portion of the first part of the first section and the second of the opposing peripheral edges of the second section defines a second recess that extends along the edge portion of the first part of the first section.

13. The pet toy according to claim 12, wherein
a first portion of the groove has a first width, a second portion of the groove has a second width that is greater than the first width, and, the first and second recesses have a third width that is less than 30% of the first width.

14. A method of manufacturing a pet toy, comprising
forming a copolymer material into a spherical-shaped inner core with an elongated non-linear groove extending along an outer surface thereof;
forming a first section of an outer covering;
forming a second section of the outer covering, the second section being formed with an elongated groove;
installing the first section of the outer covering to a first area of the outer surface of the inner core;
installing the second section to a second area of the outer surface of the inner core such that at least a portion of the second section extends into the groove; and
heating the pet toy thereby vulcanizing the inner core, the first section and the second section of the outer covering to one another.

15. The method of manufacturing a pet toy according to claim 14, wherein
the forming of the spherical-shaped inner core includes molding the copolymer material into the spherical-shaped inner core with the groove.

16. The method of manufacturing a pet toy according to claim 14, wherein
the forming of the first section of the outer covering includes rolling the first section into a thin layer.

17. The method of manufacturing a pet toy according to claim 14, wherein
the installing of the second section to the outer core includes peripheral edges of the second section overlapping with peripheral edges of the first section.

18. The method of manufacturing a pet toy according to claim 14, wherein
the heating of the pet toy includes putting the pet toy in a mold with non-linear shaped mold element being inserted into corresponding portions of the groove.
